(19) United States
(12) Patent Application Publication
(10) Pub. No.: US 2012/0167783 A1
(43) Pub. Date: Jul. 5, 2012

(54) HAM STAND

(75) Inventor: Luis Angel Barriopedro Zazo, Puerto de Santa Maria (Cadiz) (ES)

(73) Assignee: SANCHEZ ROMERO CARVAJAL JABUGO, S.A., Puerto de Santa Maria (Cadiz) (ES)

(21) Appl. No.: 13/389,186

(22) PCT Filed: Jul. 28, 2010
(86) PCT No.: PCT/ES10/70520

§ 371 Date: Mar. 23, 2012

(30) Foreign Application Priority Data
Aug. 5, 2009 (ES) U200930348

(51) Int. Cl. A47J 43/18

(52) U.S. Cl. 99/644

(57) ABSTRACT

The present invention relates to a ham stand which allows the quickly and easily inverting the position of a piece of ham once it is no longer possible to continue cutting a side thereof, without the need of having to remove and once again place the piece of ham in the ham stand, further allowing to maintain a boneless piece of ham as a rigid block, for which purpose it comprises a main bar (1) configured for being supported in a substantially horizontal position by a first support (2) and a second support (3), where said main bar (1) is configured for being integrally fixed to a side of a piece of ham and rotated about its own axis occupying two stable angular positions spaced at least 180° from one other.

### TECHNICAL FIELD OF THE INVENTION

The present invention relates to a ham stand having an application in the catering field, which allows quickly and easily inverting the position of a piece of ham once it is no longer possible to continue cutting a side thereof, without the need of having to remove and once again place the piece of ham in the ham stand, further allowing to maintain a boneless piece of ham as a rigid block, thus facilitating the cutting thereof.

### BACKGROUND OF THE INVENTION

There are currently numerous models of ham stands which are used for the positioning and immobilisation of a piece of ham for the purpose of cutting said ham, usually into slices, without the need for the user to manually hold the ham during said cutting, which substantially facilitates said operation.

Usually, the ham stands existing today have sharp elements, such as spikes or hooks, configured for piercing the piece of ham; in some cases they also have support means for the bearing of the part of the piece closest to the hoof of the ham.

The main drawback of these ham stands is that once the bone has been reached and cutting one side of the ham is no longer possible, it is necessary to handle the ham, remove it from the ham stand and again place it on the side that is left to be cut, with the inconvenience that it entails.

Said drawback is accentuated in the catering field where there is a much faster consumption of ham than in the domestic one, thus requiring the position change operation to be carried out much more frequently, for which purpose a waiter must waste a certain amount of time which he cannot dedicate to other tasks, in addition to the drawback that it entails.

On the other hand, ham stands today cannot be used for cutting boneless pieces due to the fact that the fixing means which they have for immobilising the piece require the collaboration of the bone of the legs themselves so that the piece behaves as a solid or rigid block. The boneless pieces deform and buckle in current ham stands, preventing these pieces from being sliced.

### DESCRIPTION OF THE INVENTION

The present invention relates to a ham stand which allows quickly and simply inverting the position of a piece of ham to continue the cutting thereof in a without needing to handle the ham.

The ham stand proposed by the invention comprises a main bar configured for being supported in a substantially horizontal position by a first support and a second support, where said main bar is configured for being integrally fixed to a side of a piece of ham, for which purpose it comprises fixing means.

The main bar is also configured for rotating about its own axis, taking up two stable angular positions spaced at least 180° from one another, which enables inverting the position of the ham fixed to said main bar. In terms of stable positions, these are understood as those that are maintained in a stable balanced position when there is no action on the ham stand, although said main bar can stop taking up said stable positions when a user, for example a waiter, acts on the ham stand.

The possibility of the ham stand comprising a secondary bar is considered, said secondary bar arranged substantially parallel to the main bar, configured for being integrally fixed to the piece of ham on a side opposite that of the main bar, such that said fixing is more secure, in addition to enabling the boneless pieces of ham to be maintained as a rigid block during the cutting thereof. In such case, it is contemplated that said main bar and secondary bar comprise a plurality of spikes such as by way of nails orientated inwardly and configured for piercing the piece of ham.

Finally, it is contemplated that the main bar, in proximity with its bearing in the second support, is fixed to a cross-piece extending in a direction perpendicular both to the main bar itself and to the bent end. Said cross-piece comprises a plurality of U-shaped stops configured for retaining the bent ends of two anti-buckling bars in a plurality of positions, each of said anti-buckling bars configured for perimetrically surrounding a side face of the piece of the ham.

Said anti-buckling bars extend from an anti-buckling shaft configured for transversely traversing the main bar in proximity with the first support, such that said anti-buckling bars are configured for laterally surrounding the piece of ham, their bent ends being retained in the U-shaped stops, which allows gradually modifying the position of the anti-buckling bars depending on the height at which the ham is being cut, without interfering with the knife, thus maintaining a boneless piece of ham as a rigid block, facilitating the cutting thereof.

Therefore, according to the described invention, the ham stand proposed by the invention is an advance in ham stands used up until now and solves in a fully satisfactory manner the problems described above in terms of allowing quickly and easily inverting the position of a piece of ham without the need of having to remove and once again place the ham in the ham stand, further allowing to maintain a boneless piece of ham as a rigid block facilitating the cutting thereof.

### DESCRIPTION OF THE DRAWINGS

To complement the description that is being made and for the purpose of aiding to better understand the features of the invention according to a preferred practical embodiment thereof, a set of drawings is attached as an integral part of said description in which the following has been depicted with an illustrative and non-limiting character:

FIG. 1 shows a perspective view of the ham stand proposed by the invention.

FIG. 2 shows a perspective view of the ham stand, in which the main bar is turned 180° with respect to the position depicted in FIG. 1.

FIG. 3 shows an upper perspective view of a detail of the ham stand in which the notched and cylindrical guides which allow the movement and locking of the secondary bar with respect to the main bar can be seen.

### PREFERRED EMBODIMENT OF THE INVENTION

In view of the mentioned figures it can be observed how in one of the possible embodiments of the invention, the ham stand proposed by the invention comprises a main metal bar (1) of circular section which is supported in the horizontal position by a first support (2), formed by a bent sheet, and a second support (3) also formed by bars, where said main bar (1) is configured for being integrally fixed to a side of a piece of ham. The supports (2, 3), which are metallic for strength purposes, are fixed on a base (16) preferably made of wood for aesthetic purposes.

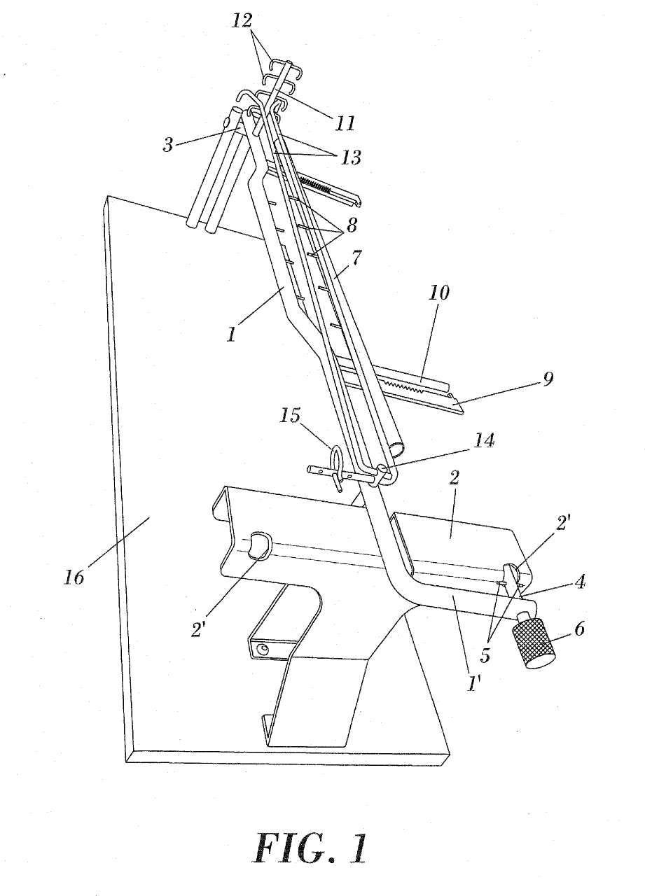

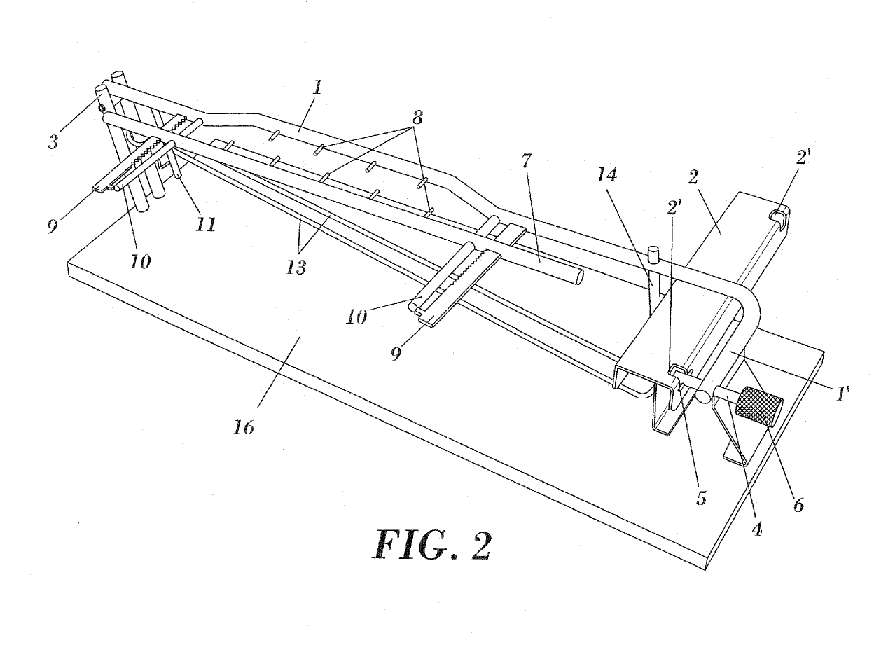

Said main bar (1) is configured for rotating about its own axis, taking up two stable angular positions spaced 180° from one another, which have been depicted in FIGS. 1 and 2, whereby thus inverting the position of the ham fixed to said main bar (1). To that end, the main bar (1) has a bent end (1′) bent transversely to the direction of the main bar (1), where the free end of said bent end (1′) is traversed by a bolt (4) which is configured for being housed in two notches (2′) comprised by the first support (2), said housing determining the two stable angular positions of the main bar (1). Therefore, by a simple turn with one hand, a waiter can invert the position of a ham very quickly, even when his other hand is occupied.

In turn, the notches (2′) are aligned with one another according to a substantially horizontal direction, whereas the bolt (4) comprises at least one stop (5) limiting its housing in each notch (2′), preventing the bolt (4) from being housed beyond what is allowed by the stops (5). The bolt (4) in turn comprises a head (6), located externally at the bent end (1′), configured for housing and extracting the bolt (4) from each notch (2′) as well as for acting on the main bar (1), causing its rotational movement. Said head (6) has a knurled outer surface for better gripping and is constituted as the element for driving the turning of the main bar (1) for users of the ham stand.

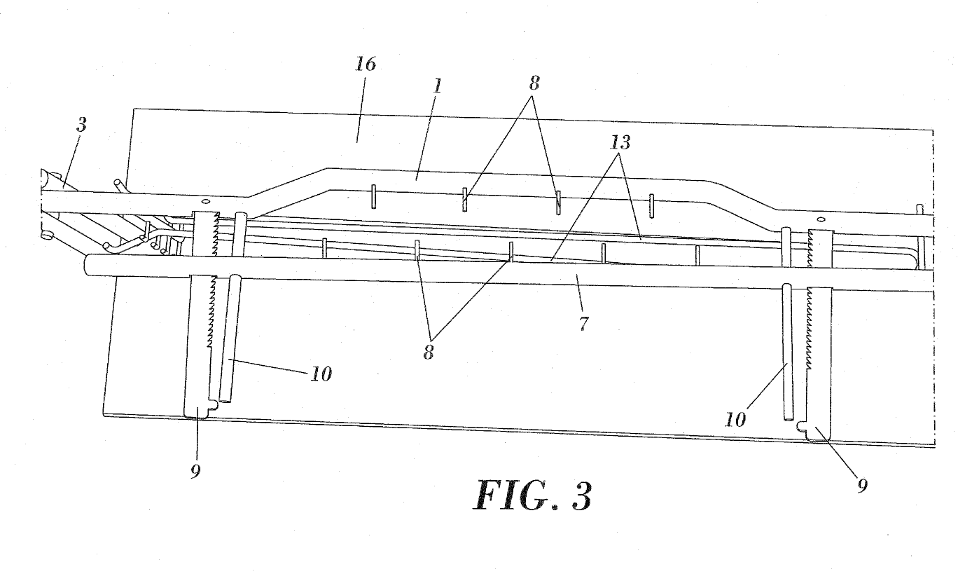

As can be seen in the figures, particularly in FIG. 3, the main bar (1) has a broken central sector which allows facilitating the housing of the side of the ham, given the plan projection of said ham when it is placed in the cutting position.

On the other hand, as can be clearly seen in FIG. 3, the ham stand comprises a secondary bar (7), also having a circular section and metallic, arranged substantially parallel to the main bar (1), where said secondary bar (7) is configured for being integrally fixed to the piece of ham on a side opposite that of the main bar (1), such that said fixing is more secure.

Said main bar (1) and secondary bar (7) comprise a plurality of staggered spikes (8) depending on if they are located in the main bar (1) or in the secondary bar (7), being orientated inwardly and configured for piercing the piece of ham.

In turn, the secondary bar (7) is configured for moving with respect to the main bar (1), being maintained substantially parallel in one and the same horizontal plane to said main bar (1), where said movement is guided by two cylindrical guides (10) transversely extending from the main bar (1).

As can be seen in FIG. 3, the secondary bar (7) is configured for being locked in a plurality of positions defined by a plurality of teeth that have at least two notched guides (9) arranged parallel next to the cylindrical guides (10).

Said notched guides (9) are articulated to the main bar (1) and actuated by elastic torsion means, such as coil springs, maintaining said notched guides (9) in the locking position by default, the unlocking of the secondary bar (7) being allowed by means of a slight turn of each notched guide (9) with respect to its articulation to the main bar (1).

According to a preferred embodiment, the wedge configuration of the teeth allows successively bringing the bars (1, 7) closer together without mutually separating the notched guides (9), whereas the secondary bar (7) cannot be moved away without performing the unlocking operation, i.e., without mutually separating the notched guides (9).

On the other hand, in proximity with its bearing in the second support (3), the main bar (1) is fixed to a cross-piece (11) extending in a direction perpendicular both to the main bar itself (1) and to the bent end (1′). Said cross-piece (11) comprises a plurality of U-shaped stops (12) configured for retaining the bent ends of two anti-buckling bars (13) in a plurality of positions.

Said anti-buckling bars (13) extend from an anti-buckling shaft (14) configured for transversely traversing the main bar (1), parallel to the cross-piece (11), in proximity with the first support (2), such that said anti-buckling bars (13) are configured for laterally surrounding the piece of ham, their bent ends being retained in the U-shaped stops (12), which allows gradually modifying the position of the anti-buckling bars (13) depending on the height at which the ham is being cut, without interfering with the knife, thus maintaining a boneless piece of ham as a rigid block, facilitating the cutting thereof.

The distance between the anti-buckling bars (13) upon their passage through the anti-buckling shaft (14) is adjustable by means of a pin (15) configured for being housed in a plurality of holes existing at one end of at least one of said anti-buckling bars (13) passing through the anti-buckling shaft (14), which allows being adapted to pieces of different widths, or to the different widths according to the height at which the cut is being made in a piece of ham.

In view of this description and set of drawings, a person skilled in the art will be able to understand that the embodiments of the invention that have been described can be combined in multiple ways within the object of the invention. The invention has been described according to some preferred embodiments thereof, but it will be evident for the person skilled in the art that many variations can be introduced in said preferred embodiments without exceeding the object of the claimed invention.

1. Ham stand, characterised in that it comprises a main bar (1) configured for being supported in a substantially horizontal position by a first support (2) and a second support (3), where said main bar (1) is configured for being integrally fixed to a side of a piece of ham and rotated about its own axis, taking up two stable angular positions spaced at least 180° from one other.

2. Ham stand according to claim 1, characterised in that the main bar (1) has a bent end (1′) bent transversely to the direction of the main bar (1), where the free end of said bent end (1′) is traversed by a bolt (4) configured for being housed in two notches (2′) comprised by the first support (2), said housing determining the two stable angular positions of the main bar (1).

3. Ham stand according to claim 2, characterised in that the notches (2′) are aligned with one another according to a substantially horizontal direction, the bolt (4) comprising at least one stop (5) limiting its housing in each notch (2′), and said bolt (4) comprising a head (6), located externally to the bent end (1′), configured for housing and extracting the bolt (4) from each notch (2′) as well as for acting on the main bar (1), causing its rotational movement.

4. Ham stand according to claim 1, characterised in that it comprises a secondary bar (7) arranged substantially parallel to the main bar (1), configured to be integrally fixed to the piece of ham on a side opposite that of the main bar (1), where said main bar (1) and secondary bar (7) comprise a plurality of nails (8) configured for piercing the piece of ham.

5. Ham stand according to claim 4, characterised in that the secondary bar (7) is configured for moving with respect to the main bar (1), being maintained substantially parallel to said main bar (1), where said movement is guided by at least two cylindrical guides (10) extending transversely from the main bar (1).

6. Ham stand according to claim 5, characterised in that the secondary bar (7) is configured for being locked in a plurality of positions defined by a plurality of teeth that have at least two notched guides (9) arranged parallel next to the cylindrical guides (10), where said notched guides (9) are articulated to the main bar (1) and actuated by elastic torsion means maintaining said notched guides (9) in the locking position by default, the unlocking of the secondary bar (7) being allowed by means of a slight turn of each notched guide (9) with respect to its articulation to the main bar (1).

7. Ham stand according to claim 2, characterised in that in proximity with its bearing in the second support (3) the main bar (1) is fixed to a cross-piece (11) extending in a direction perpendicular to both the main bar (1) itself and to the bent end (1′), said cross-piece (11) comprising a plurality of U-shaped stops (12) configured for retaining in a plurality of positions the bent ends of two anti-buckling bars (13) extending from an anti-buckling shaft (14) configured for traversing the main bar (1) in proximity with the first support (2), where said anti-buckling bars (13) are configured for laterally surrounding the piece of ham maintaining said piece of ham as a rigid block.

8. Ham stand according to claim 7, characterised in that the distance between the anti-buckling bars (13) upon their passage through the anti-buckling shaft (14) is adjustable by means of a pin (15) configured for being housed in a plurality of holes existing at one end of at least one of said anti-buckling bars (13) passing through the anti-buckling shaft (14).
